(19) United States
(12) Patent Application Publication
(10) Pub. No.: US 2014/0047370 A1
(43) Pub. Date: Feb. 13, 2014

(54) METHOD AND APPARATUS FOR COPY-AND-PASTE OF OBJECT

(71) Applicant: Samsung Electronics Co., Ltd., Gyeonggi-do (KR)

(72) Inventors: Chan-Young Moon, Gyeonggi-do (KR); Dong-Min Ok, Seoul (KR)

(73) Assignee: Samsung Electronics Co., Ltd., Gyeonggi-do (KR)

(21) Appl. No.: 13/961,853

(22) Filed: Aug. 7, 2013

(30) Foreign Application Priority Data
Aug. 7, 2012 (KR) 10-2012-0086247

(51) Int. Cl. G06F 3/0484

(52) U.S. Cl. CPC G06F 3/0484
USPC 715/770

(57) ABSTRACT

A method and an apparatus for copy-and-paste of a GUI object are provided. The method includes sensing a multi-touch gesture event and copying at least one GUI object. The multi-touch gesture event includes either a multi-tap and hold gesture event or a multi-tap gesture event. An electronic device for copy and paste of a GUI object comprises a touch screen, at least one or more processors, a memory, and at least one or more modules, each of the one or more modules being stored in the memory and being configured to be executed by the one or more processors, wherein the at least one or more modules is configured to sense a multi-touch gesture event on the touch screen and to copy at least one GUI object.

### CROSS-REFERENCE TO RELATED APPLICATION(S) AND CLAIM OF PRIORITY

The present application is related to and claims the benefit under 35 U.S.C. §119(a) of a Korean patent application No. 10-2012-0086247 filed in the Korean Intellectual Property Office on Aug. 7, 2012, the entire disclosure of which is hereby incorporated by reference.

### TECHNICAL FIELD

The present disclosure relates to a method and an apparatus for copying and pasting an object(s) via a Graphic User Interface (GUI).

### BACKGROUND

Recently, as portable electronic devices have rapidly come into wide use, they have become the necessities of life for modem people. These portable electronic devices have developed into multimedia communication devices capable of providing various data transmission services and various additional services as well as an original voice communication service. The services capable of being provided from the portable electronic device are on a trend of being increased, and User Interface (UI) technologies for controlling the portable electronic devices are also on a trend of being continuously developed.

Also, each of the portable electronic devices is pursuing convenience for input of a user by applying a touch screen based on a GUI. For example, if the user of the portable electronic device touches a GUI object, for example, an icon, displayed on a touch screen, the portable electronic device performs a function for the touched icon. This interface through the touch screen between the user and the portable electronic device enhances satisfaction of the user. While utilization degree of each of the portable electronic devices applying the touch screen is enhanced, the user shows a trend of preferring a larger touch screen.

The portable electronic device performs a process of copying an icon. For example, the user must perform a certain process of selecting a file to be copied, reading a separate menu, selecting a copy item on the menu, and specifying a copy position on the menu. That is, although a conventional portable electronic device has a touch screen, the user may copy an icon through a process of separately pushing and operating buttons in a conventional method of copying a GUI object. Therefore, this conventional method of copying the GUI object degrades the utilization degree of the touch screen.

### SUMMARY

To address the above-discussed deficiencies of the prior art, it is a primary object to provide a method and apparatus for generating a GUI object to copy the GUI object simply and conveniently using a multi-touch gesture.

Another aspect of the present disclosure is to provide a method and apparatus for copy- and-paste of a GUI object to sense a multi-tap and hold gesture event, determine a copied target, sense a drag gesture event which is successively generated in a multi-tap and hold gesture state, and change a paste position.

Another aspect of the present disclosure is to provide a method and apparatus for copy and paste of a GUI object to sense a multi-tap gesture event, determine a previously selected GUI object as a copied target, temporarily store a copied object for the GUI object, sense a multi-tap gesture event, and paste the temporarily stored copied object to a corresponding paste position.

In accordance with an aspect of the present disclosure, a method of copy-and-paste a GUI object is provided. The method includes sensing a multi-touch gesture event and copying at least one GUI object.

In accordance with another aspect of the present disclosure, an apparatus for copy-and-paste of a GUI object is provided. The apparatus includes a touch screen, at least one or more processors, a memory, and at least one or more modules, each of the one or more modules which is stored in the memory and is configured to be executed by the one or more processors, wherein each of the one or more modules senses a multi-touch gesture event on the touch screen and copies at least one GUI object

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating configuration of an electronic device according to one embodiment of the present invention;

FIG. 2 illustrates a process of copy-and-paste of an object(s) via GUI according to one embodiment of the present disclosure;

FIGS. 3 to 9 illustrate interfaces for a process of copy-and-paste of an object(s) via GUI according to one embodiment of the present disclosure;

FIG. 10 is a flowchart illustrating a process of copy-and-paste of an object (s) via GUI according to another embodiment of the present disclosure; and

FIGS. 11 and 12 illustrate interfaces for a process of copy-and-paste of an object(s) via GUI according to another embodiment of the present disclosure.

### DETAILED DESCRIPTION

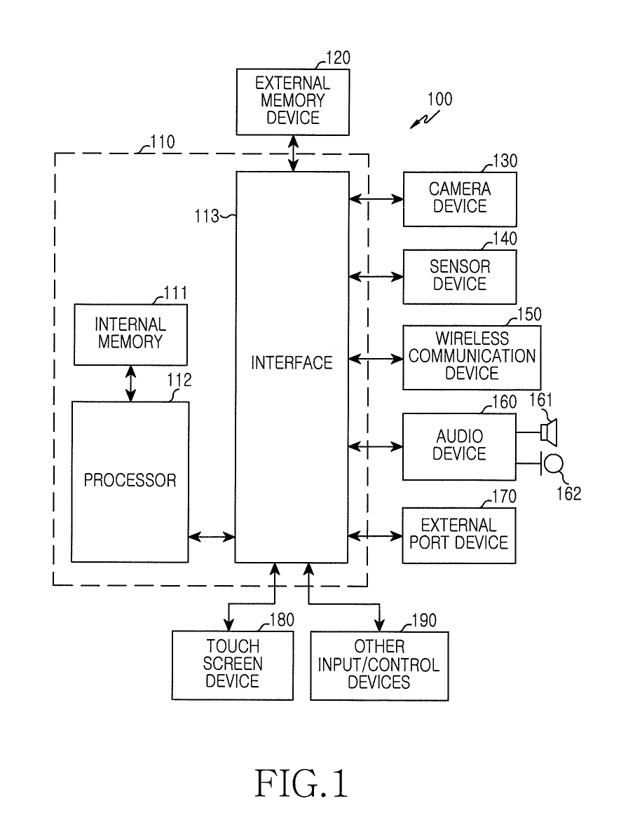

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present invention will be described herein below with reference to the accompanying drawings. In the following description, well-known functions or constructions are not described in detail since they would obscure the invention in unnecessary detail.

FIG. 1 is a block diagram illustrating configuration of an electronic device according to one embodiment of the present invention.

This electronic device denoted by 100 can be a portable electronic device such as a portable terminal, a mobile phone, a mobile pad, a media player, a tablet computer, a handheld computer and a Personal Digital Assistant (PDA). Also, the electronic device can be a certain portable electronic device including a device in which two or more functions are combined among these apparatuses.

The electronic device 100 includes a host device 110, an external memory device 120, a camera device 130, a sensor device 140, a wireless communication device 150, an audio device 160, an external port device 170, a touch screen device 180 and other input/control devices 190. The external memory device 120 and the external port device 170 can be a plurality of external memory devices and external port devices, respectively.

The host device 110 includes an internal memory 111, one or more processors 112, and an interface 113. The internal memory 111, the one or more processors 112 and the interface 113 can be separately configured or can be configured in one or more Integrated Circuits (ICs).

The processor 112 executes several software programs and performs several functions for the electronic device 100. The processor 112 performs process and control for audio communication, video communication, and data communication. In addition to these general functions, the processor 112 executes a software module (instruction set) stored in the internal memory 111 and/or the external memory device 120 and performs several functions corresponding to the software module. Also, in addition to these general functions, the processor 112 plays a role in executing a specific software module (instruction set) stored in the internal memory 111 and/or the external memory device 120 and performing several specific functions corresponding to the specific software module. That is, the processor 112 interworks with software modules stored in the internal memory 111 and/or the external memory devices 120 and performs embodiments of the present invention. Also, the processor 112 can include one or more data processors, an image processor, or a codec. In addition, the electronic device 100 can include the data processor, the image processor or the codec, separately.

The interface 113 connects the host device 110 with several devices of the electronic device 100.

Particularly, in accordance with one embodiment of the present invention, the processor 112 controls the camera device 130. The camera device 130 can perform a camera function such as a photo and video clip recording function. The camera device 130 includes a Charge Coupled Device (CCD) or a Complementary Metal Oxide Semiconductor (CMOS). The camera device 130 adjusts hardware-like configuration changes, for example, lens movement, the F-number of a diaphragm, and the like by a camera module executed by the processor 112.

Various components of the electronic device 100 can be connected through one or more communication buses (not written in reference numbers) or stream lines (not written in reference numbers).

The sensor device 140 can include a motion sensor, an optical sensor, a temperature sensor, etc. and can perform several functions. For example, the motion sensor can sense motion of the electronic device 100. The optical sensor can sense light around the electronic device 100.

The wireless communication device 150 can perform wireless communication. The wireless communication device 150 can include a Radio Frequency (RF) transceiver and a light (e.g., infrared ray) transceiver. The wireless communication device 150 can be designed to operate through one of communication networks, such as a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless-Fidelity (Wi-Fi) network, a Worldwide interoperability for Microwave Access (WiMax) network, or/and a Bluetooth network.

The audio device 160 connects to a speaker 161 and a microphone 162 and is responsible for audio input and output functions such as a voice recognition function, a voice copy function, a digital recording, function and a phone call function. That is, the audio device 160 communicates with a user through the speaker 161 and the microphone 162. Also, the audio device 160 receives a data signal from the host device 110, converts the received data signal into an electric signal, and outputs the converted electric signal through the speaker 161. The speaker 161 converts a band of the electric signal into an audible frequency band and outputs the converted signal. The microphone 162 converts sound waves transmitted from people or other sound sources into electric signals. Also, the audio device 160 receives an electric signal from the microphone 162, converts the received electric signal into an audio data signal, and transmits the converted audio data signal to the host device 110. The audio device 160 can include an earphone, a headphone, or a headset which is attachable and detachable to the electronic device 100.

The external port device 170 connects the electronic device 100 to another electronic device directly or connects it to another electronic device indirectly through a network (e.g., the Internet, an intranet, a wireless Local Area Network (LAN), and the like).

The touch screen device 180 provides an input and output interface between the electronic device 100 and the user. The touch screen device 180 applies touch sensing technologies, transmits touch input of the user to the host device 110, and provides visual information, such as texts, graphics, videos, etc., provided from the host device 110, to the user. Also, the touch screen device 180 can further apply not only capacitive, resistive, infrared ray, and surface acoustic wave technologies but also certain multi-touch sensing technologies including other proximity sensor arrays or other elements.

The other input/control devices 190 can include an up/down button for volume control. In addition, the other input/control devices 190 can include at least one of pointer devices, such as a push button, a rocker button, a locker switch, a thumb wheel, a dial, a stick, and a stylus, each of them which have a corresponding function.

The external memory device 120 includes a high-speed Random Access Memory (RAM) such as one or more magnetic storages, a non-volatile memory, one or more optical storages, and/or a flash memory (e.g., a NAND flash memory or a NOR flash memory). The external memory device 120 includes software components. The software components include an Operating System (OS) module, a communication module, a graphic module, a UI module, a CODEC module, a camera module, one or more application modules, a GUI object copying module, a GUI object generating module, and the like. The term “modules” can be expressed in a set of instructions, an instruction set, or programs.

The OS module indicates an embedded OS such as Windows, Linux, Darwin, RTXC, UNIX, OS X, or VxWorks. The OS module includes several software components for controlling a general system operation. For example, control of this general system operation includes memory management and control, storage hardware (device) control and management, power control and management, and the like. In addition, the OS module also performs a function for smoothly communicating between several hardware components (devices) and software components (modules).

The communication module can communicate with target electronic devices such as a computer, a server, and a portable terminal through the wireless communication device 150 or the external port device 170.

The graphic module includes several software components for providing and displaying graphics on the touch screen device 180. The term “graphics” indicates texts, web pages, icons, digital images, videos, animations, and the like.

The UI module includes several software components related to a UI. In addition, the UI module includes contents about whether a state of a UI is changed to any state, whether a state of a UI is changed in any condition, and the like.

The CODEC module can include software components related to encoding and decoding of video files.

The application module includes a browser function, an email function, an instant message function, a word processing function, a keyboard emulation function, an address book function, a touch list function, a widget function, a Digital Right Management (DRM) function, a voice recognition function, a voice copy function, a position determining function, a location based service function, and the like. The external memory device 120 can further include additional modules for instructions in addition to the above-described modules.

The GUI object copying module senses a multi-tap and hold gesture event, copies at least one GUI object, senses a drag gesture event which is successively performed from the multi-tap and hold gesture event, and changes a paste position along a drag path of the drag gesture event. When the drag gesture event is ended, the GUI object copying module pastes at least the copied one GUI object to the changed paste position. Also, the GUI object copying module determines at least one GUI object selected by a multi-tap and hold gesture event as a copied target or determines at least previously selected one GUI object as a copied target.

Also, the GUI object generating module senses a multi-tap gesture event, copies at least previously selected one GUI object, senses a corresponding gesture event, and changes a paste position. The GUI object generating module senses a multi-tap gesture event and pastes at least the copied one GUI object to the changed paste position.

The GUI objects include items of a list, icons, and the like. Positions to which these GUI objects are copied are a position in a list, a position out of the list, a position in a folder, a position out of the folder, a position on a page, and the like.

Also, a variety of functions of the electronic device 100 according to one embodiment of the present disclosure can be executed by one or more streaming processing, hardware including an Application Specific Integrated Circuit (ASIC), software, and/or combination of them.

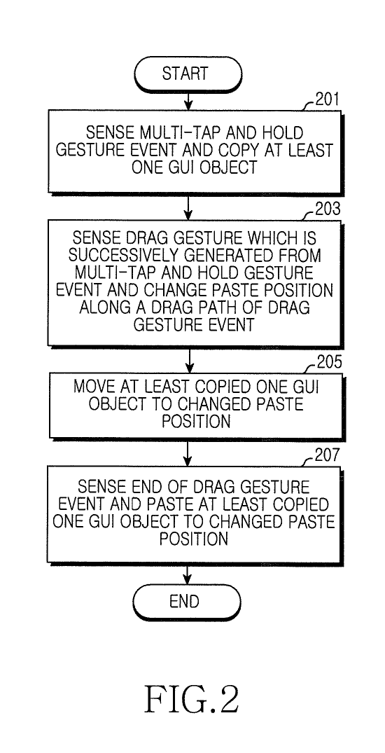

FIG. 2 illustrates a process of copy-and-paste of a GUI object according to one embodiment of the present disclosure.

Referring to FIGS. 1 and 2, the processor 112 senses a multi-tap and hold gesture event and determines at least one GUI object as a copied target in step 201. A multi-top and hold gesture means a gesture for holding a touch with two or more fingers during a threshold time or more. For example, an icon touched by the multi-tap and hold gesture is copied. Also, it is assumed that a plurality of icons are predetermined. If a user touches the plurality of predetermined icons using a multi-tap and hold gesture, the plurality of predetermined icons are copied.

The processor 112 senses a drag gesture event which is successively performed after the multi-tap and hold gesture event and changes a paste position along a drag path of the drag gesture event in step 203. A drag gesture means a gesture for moving the two or more fingers in a state where the user touches the icon. That is, the gesture from step 201 to step 203 means a process of holding the touch on one place with the two or more fingers during the threshold time or more and moving the two or more fingers.

The processor moves at least the copied one GUI object to the changed paste position in step 205. That is, the processor 112 moves at least the copied one GUI object along a path of a drag.

The processor 112 senses end of the drag gesture event and pastes at least the copied one GUI object to the changed paste position in step 207.

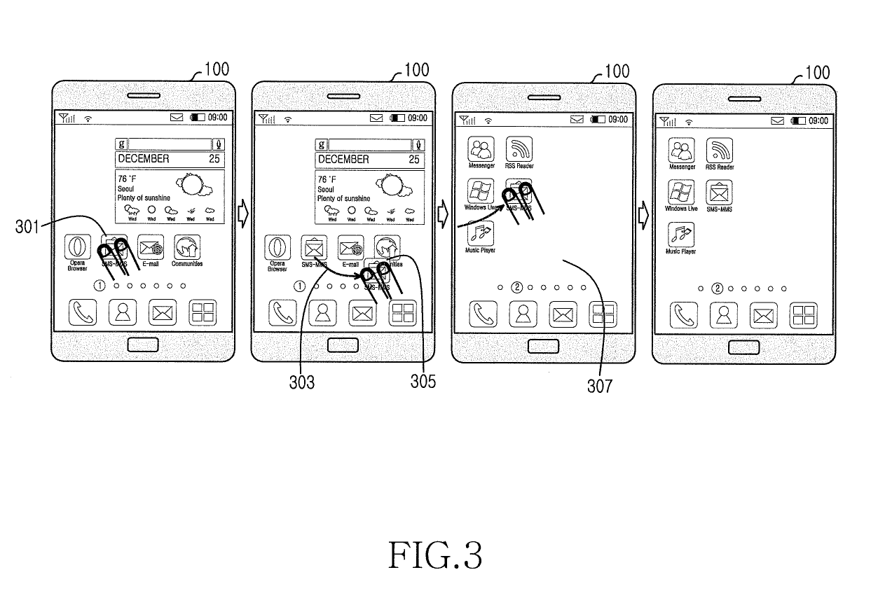

The procedure of FIG. 2 will be described below in detail with reference to FIGS. 3 to 9.

FIG. 3 illustrates an interface for a process of copy-and-paste of an object(s) according to one embodiment of the present disclosure.

Referring to FIG. 3, if a user touches an icon 301 by a multi-tap and hold gesture using his or her two fingers, an electronic device 100 generates an icon 305 which is copied from the touched icon 301.

If the user performs a drag gesture which is successively generated in a multi-tap and hold gesture touch state, the electronic device 100 moves the copied icon 305 along a drag path 303.

If the user moves the his or her two fingers onto a right-side edge of a screen of the electronic device 100 using the drag gesture, the electronic device 100 changes a current screen to a next screen 307 and holds the movement of the copied icon 305 by the drag gesture.

If the user ends the drag gesture, that is, if he or she takes off his or her two fingers, the electronic device 100 pastes the copied icon 305 to a position where the drag gesture is ended.

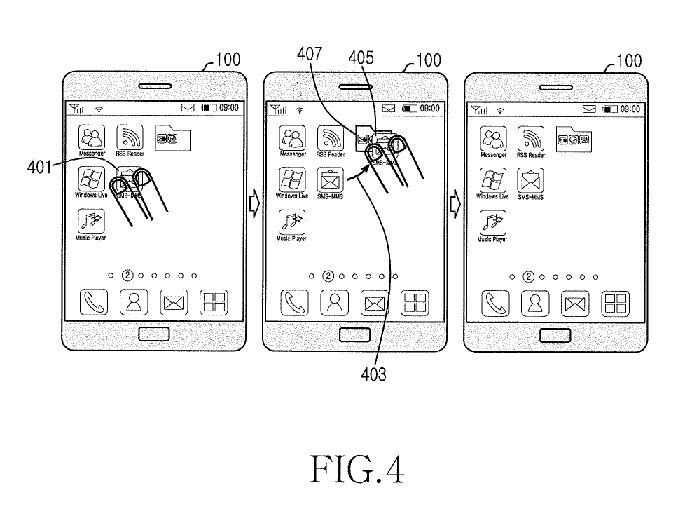

FIG. 4 illustrates an interface for a process of generating a GUI object according to one embodiment of the present disclosure.

Referring to FIG. 4, if a user touches an icon 401 by a multi-tap and hold gesture using his or her two fingers, an electronic device 100 generates an icon 405 which is copied from the touched icon 401.

If the user performs a drag gesture in a multi-tap and hold gesture touch state, the electronic device 100 moves the copied icon 405 along a drag path 403.

If the user moves the copied icon 405 onto a folder icon 407 by the drag gesture and then ends the drag gesture, the electronic device 100 pastes the copied icon 405 to a folder of the folder icon 407.

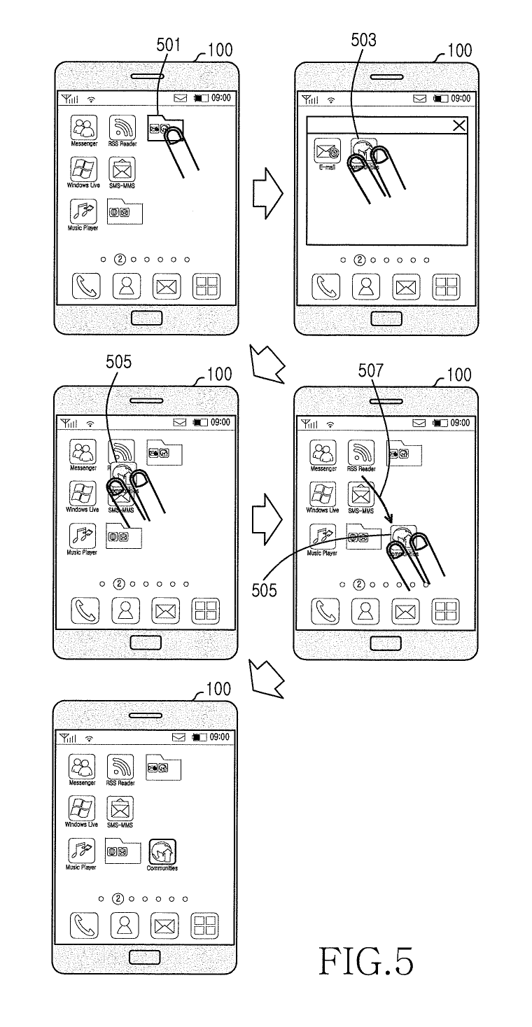

FIG. 5 illustrates an interface for a process of copy-and-paste of a GUI object according to one embodiment of the present disclosure.

Referring to FIG. 5, if a user touches a folder icon 501, an electronic device 100 opens the folder of the touched folder icon 501 and displays icons which are contained in the folder.

If the user touches an icon 503, one of the icons contained in the opened folder by a multi-tap and hold gesture using his or her two fingers, the electronic device 100 generates an icon 505 which is copied from the touched icon 503. In some embodiments, if the user closes the opened folder, the electronic device 100 can move the copied icon 505 by a drag gesture.

If the user performs a drag gesture in a multi-tap and hold gesture touch state, the electronic device 100 moves the copied icon 505 along a drag path 507.

If the user moves the copied icon 505 onto a position out of the folder icon 501 by the drag gesture and then ends the drag gesture, the electronic device 100 pastes the copied icon 505 to the position out of the folder icon 501.

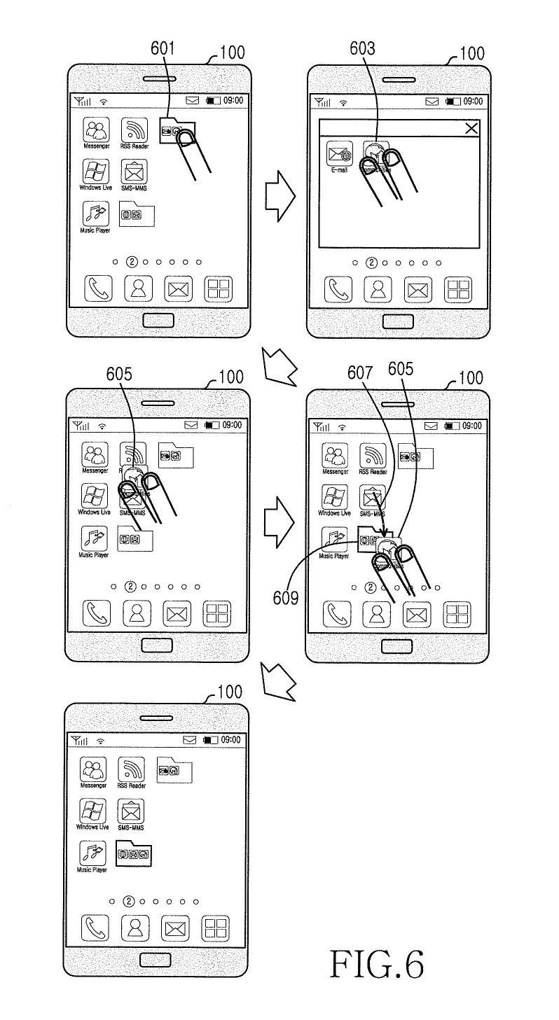

FIG. 6 illustrates an interface for a process of copy-and-paste of a GUI object according to one embodiment of the present disclosure.

Referring to FIG. 6, if a user touches a folder icon 601, an electronic device 100 opens a folder of the touched folder icon 601 and displays icons that were contained in the folder.

If the user touches an icon 603 included in the opened folder by a multi-tap and hold gesture using, his or her two fingers, the electronic device 100 generates an icon 605 which is copied from the touched icon 603. If the user closes the opened folder, the electronic device 100 can move the copied icon 605 by a drag gesture.

If the user performs the drag gesture in a multi-tap and hold gesture touch state, the electronic device 100 moves the copied icon 605 along a drag path 607.

If the user moves the copied icon 605 onto another folder icon 609 by the drag gesture and then ends the drag gesture, the electronic device 100 pastes the copied icon 605 to a folder of the folder icon 609.

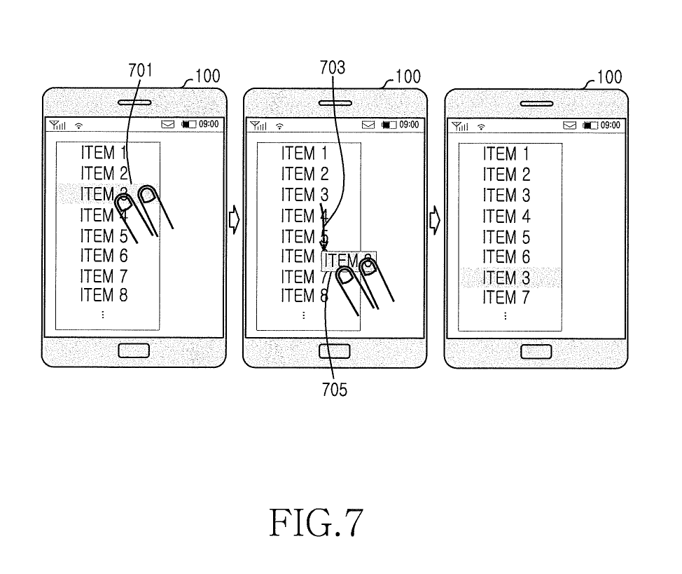

FIG. 7 illustrates an interface for a process of generating a GUI object according to one embodiment of the present disclosure.

Referring to FIG. 7, if a user touches an item 701 in a list by a multi-tap and hold gesture using his or her two fingers, an electronic device 100 can generate an item 705 which is copied from the touched item 701 and can move the copied item 705 by a drag gesture.

If the user performs the drag gesture in a multi-tap and hold gesture touch state, the electronic device 100 moves the copied item 705 along a drag path 703.

If the user moves the copied item 705 to a certain position in the list by the drag gesture and then ends the drag gesture, the electronic device 100 pastes the copied item 705 to the certain position in the list.

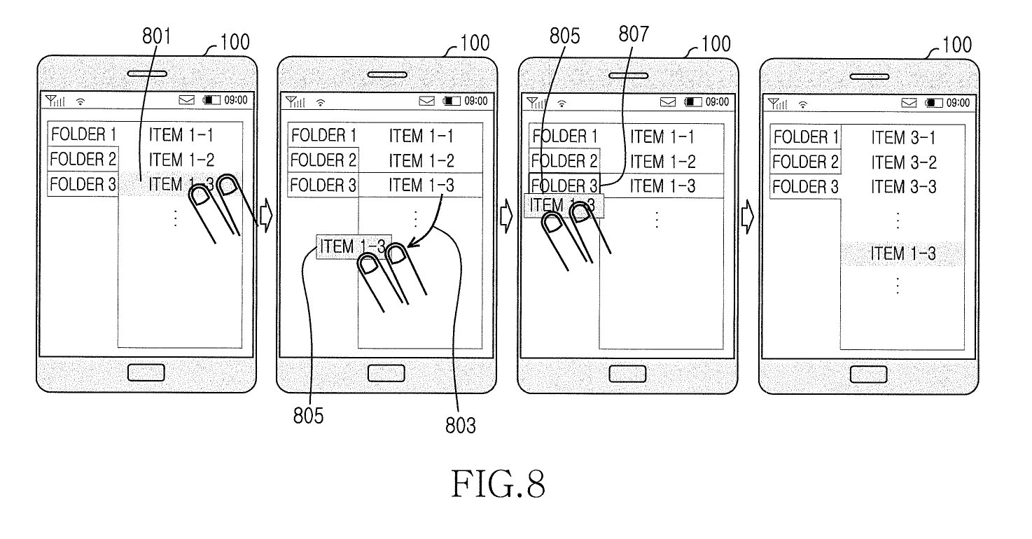

FIG. 8 illustrates an interface for a process of copy-and-paste a GUI object according to one embodiment of the present disclosure.

Referring to FIG. 8, an electronic device 100 displays a folder and items in the folder on a list. If a user touches an item 801 in the folder by a multi-tap and hold gesture using his or her two fingers, an electronic device 100 can generate an item 805 which is copied from the touched item 801 and can move the copied item 805 by a drag gesture.

If the user performs the drag gesture in a multi-tap and hold gesture touch state, the electronic device 100 moves the copied item 805 along a drag path 803.

If the user moves the copied item 805 onto another folder 807 by the drag gesture and then ends the drag gesture, the electronic device 100 pastes the copied item 805 to the another folder 807.

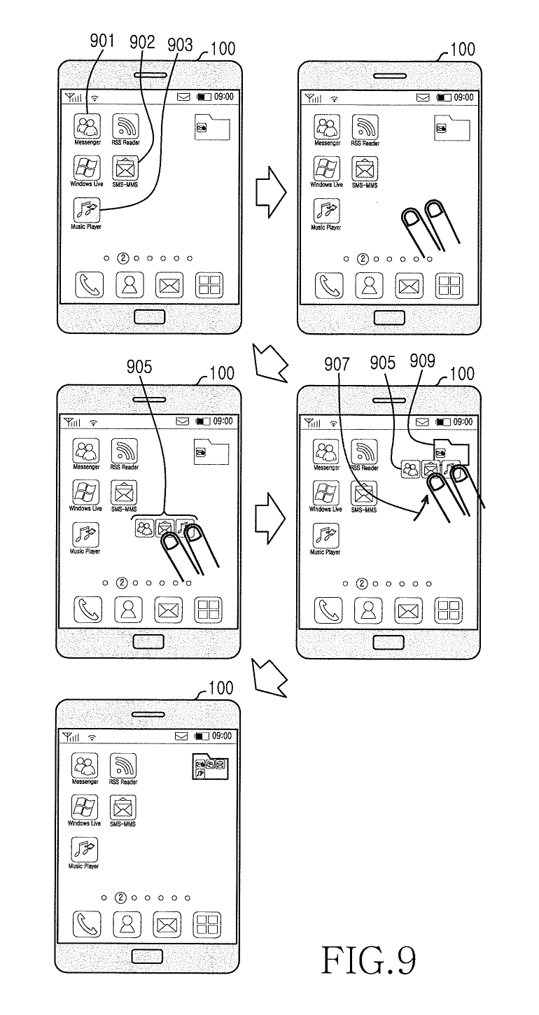

FIG. 9 illustrates an interface for a process of copy-and-paste a GUI object according to one embodiment of the present disclosure.

Referring to FIG. 9, a user selects a plurality of icons 901 to 903 to be determined as copied targets in advance. For example, the user can select icons one by one by holding a state where he or she pushes a specific button or by a touch using a single tap after pushing a specific button.

If the user performs a multi-tap and hold gesture using his or her two fingers on certain position of a screen, the electronic device 100 generates icons 905 which are copied from the previously selected icons 901 to 903 on the position where the multi-tap and hold gesture was generated, and arranges and displays the generated icons 905.

If the user performs a drag gesture in a multi-tap and hold gesture touch state, the electronic device 100 moves the copied icons 905 along a drag path 907.

If the user moves the copied icons 905 on a folder icon 909 by the drag gesture and then ends the drag gesture, the electronic device 100 pastes the copied icons 905 to the folder of the folder icon 909.

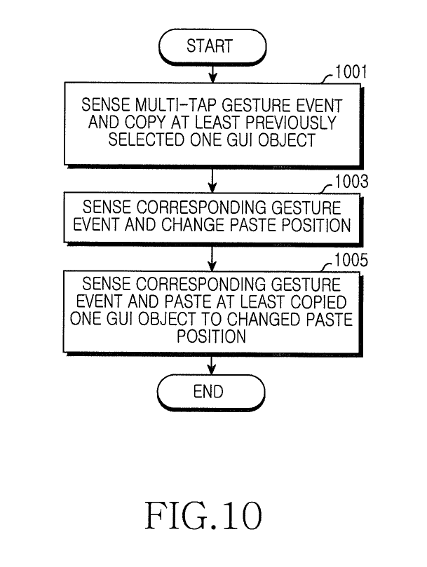

FIG. 10 is a flowchart illustrating a process of copy-and-paste a GUI object according to another embodiment of the present disclosure.

Referring to FIGS. 1 and 10, the processor 112 senses a multi-tap gesture event and copies at least one previously selected one GUI object in step 1001.

The processor 112 senses a corresponding gesture event and changes a paste position in step 1003.

The processor 112 senses the corresponding gesture event and pastes at least the copied one GUI object to the changed paste position in step 1005.

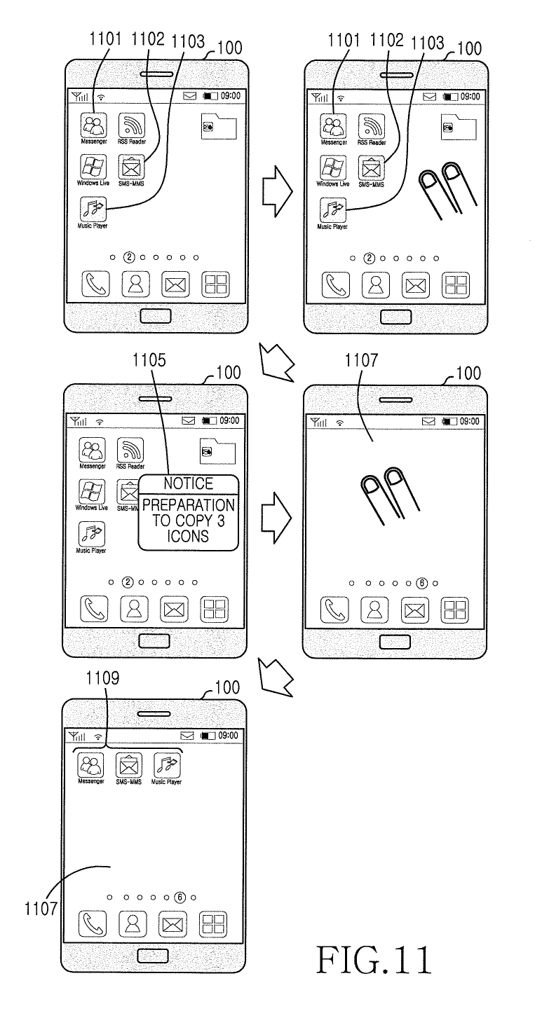

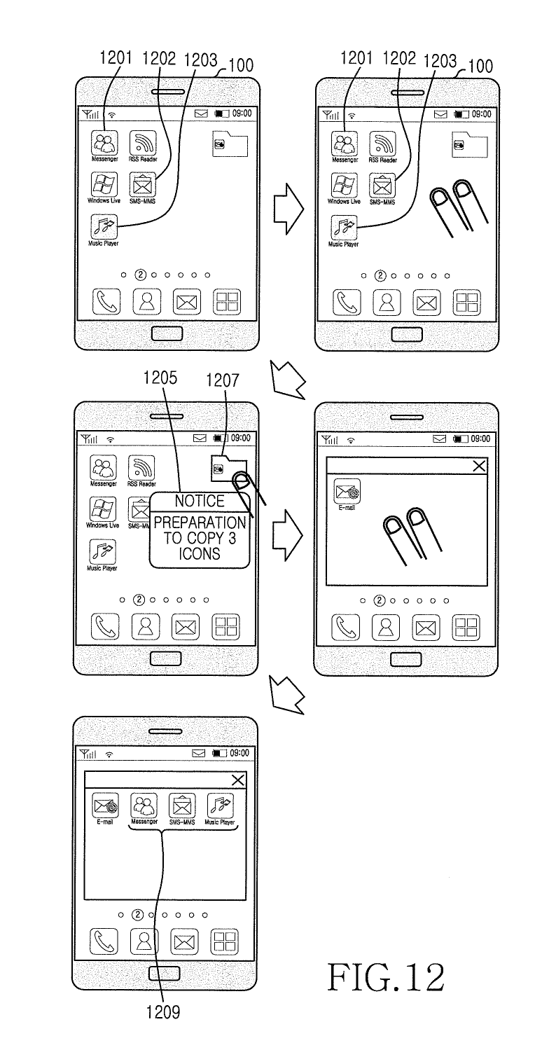

The procedure of FIG. 10 will be described below in detail with reference to FIGS. 11 and 12.

FIG. 11 illustrates an interface for a process of generating a GUI object according to another embodiment of the present disclosure.

Referring to FIG. 11, a user selects a plurality of icons 1101 to 1103 to be determined as copied targets in advance. For example, the user can select icons one by one by holding a state where he or she pushes a specific button or by a touch using a single tap after pushing a specific button.

If the user performs a multi-tap gesture using his or her two fingers on a certain position of a screen, an electronic device 100 copies the previously selected icons 1101 to 1103 and displays a notice window 1105 for informing that copy preparation is completed.

The user can change a paste position. For example, if he or she performs a left flicking gesture, the electronic device 100 changes a current page to a next page. If the user performs a right flicking gesture, the electronic device 100 changes the current page to a previous page.

If the user performs a multi-tap gesture using his or her two fingers on a changed page 1107, the electronic device 100 pastes copied icons 1109 to the changed page 1107.

FIG. 12 illustrates an interface for a process of generating a GUI object according to another embodiment of the present disclosure.

Referring to FIG. 12, a user selects a plurality of icons 1201 to 1203 to be determined as copied targets in advance.

If the user performs a multi-tap gesture using his or her two fingers on an certain position of a screen, an electronic device 100 copies the previously selected icons 1201 to 1203 and displays a notice window 1205 for informing that copy preparation is completed.

If the user changes a paste position, for example, if he or she touches a folder icon 1207 by a single tap gesture, the electronic device 100 opens a folder of the corresponding folder icon 1207.

If the user performs a multi-tap gesture using his or her two fingers in the opened folder, the electronic device 100 pastes copied icons 1209 to the opened folder.

Methods according to claims of the present disclosure and/or embodiments described in the specification of the present disclosure can be implemented as hardware, software, or combinational type of the hardware and the software.

When the method is implemented by the software, a computer-readable storage medium for storing one or more programs (software modules) can be provided. The one or more programs stored in the computer-readable storage medium are configured for being executed by one or more processors in an electronic die vice. The one or more programs include instructions for allowing an electronic device to execute the methods according to the claims of the present disclosure and/or the embodiments described in the specification of the present disclosure.

These programs (software module, software) can be stored in a RAM, a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. Alternatively, the programs can be stored in a memory configured by combination of some or all of them. Also, the configured memory can include a plurality of memories.

In conclusion, the electronic device according to embodiments of the present disclosure may copy and paste a GUI object simply and conveniently using a multi-touch gesture.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of copy-and-paste of a GUI object in an electronic device, the method comprising:
sensing a multi-touch gesture event; and
copying at least one GUI object based on the multi-touch gesture event.

2. The method of claim 1, wherein multi-touch gesture event includes either a multi-tap and hold gesture event or a multi-tap gesture event.

3. The method of claim 1, wherein the copying of at least the one GUI object comprises copying at least one selected GUI object by the multi-touch gesture event.

4. The method of claim 1, wherein the copy of at least the one GUI object comprises copying at least the one GUI object corresponding to a touch position where the multi-touch gesture event occurs.

5. The method of claim 1, further comprising pasting at least the one copied GUI object to a certain position.

6. The method of claim 5, wherein the paste of at least the one copied GUI object to the certain position comprises:
sensing a drag gesture event; and
pasting at least the one copied GUI object to a final position of a drag path of the drag gesture event.

7. The method of claim 6, wherein the paste of at least the one copied GUI object to the certain position comprises moving at least the one copied GUI object along the drag path of the drag gesture event.

8. The method of claim 5, wherein the paste of at least the one copied GUI object to the certain position comprises:
sensing a multi-touch gesture event on the certain position; and
pasting at least the one copied GUI object to the position.

9. The method of claim 5, wherein the paste of at least the one copied GUI object to the certain position comprises pasting at least the one copied GUI object to one of a position in a list, a position out of the list, a position in a folder, a position out of the folder and a position on a page.

10. The method of claim 1, wherein the GUI object includes an item of an icon or a list comprised of icons.

11. An electronic device for copy-and-paste of a GUI object, the apparatus comprising:
a touch screen;
at least one or more processors;
a memory; and
at least one or more modules, each of the one or more modules being stored in the memory and being configured to be executed by the one or more processors,
wherein the at least one or more modules is configured to sense a multi-touch gesture event on the touch screen and to copy at least one GUI object.

12. The device of claim 11, wherein each of the modules is configured to sense a multi-tap and hold gesture event or a multi-tap gesture event.

13. The device of claim 11, wherein each of the modules is configured to copy at least one previously selected GUI object.

14. The device of claim 11, wherein each of the modules is configured to copy at least the one GUI object corresponding to a touch position where the multi-touch gesture event occurs.

15. The device of claim 11, wherein each of the modules is configured to paste at least the one copied GUI object to a certain position.

16. The device of claim 15, wherein each of the modules is configured to sense a drag gesture event and pastes at least the one copied GUI object to a final position of a drag path of the drag gesture event.

17. The device of claim 16, wherein each of the modules is configured to move at least the one copied GUI object along the drag path of the drag gesture event.

18. The device of claim 15, wherein each of the modules is configured to sense a multi-touch gesture event on the certain position and pastes at least the one copied GUI object to the position.

19. The device of claim 15, wherein each of the modules is configured to paste at least the one copied GUI object to one of a position in a list, a position out of the list, a position in a folder, a position out of the folder and a position on a page.

20. The device of claim 11, wherein the GUI object includes an icon or a list comprised of icons.
